(19) United States
(12) Patent Application Publication
(10) Pub. No.: US 2022/0162775 A1
(43) Pub. Date: May 26, 2022

(54) HEAT-BONDABLE FIBER AND NONWOVEN FABRIC

(71) Applicant: FAR EASTERN NEW CENTURY CORPORATION, Taipei City (TW)

(72) Inventors: Lewis YU, Taipei City (TW); Fu Wen OU, Taipei City (TW)

(73) Assignee: FAR EASTERN NEW CENTURY CORPORATION, Taipei City (TW)

(21) Appl. No.: 17/454,961

(22) Filed: Nov. 15, 2021

(30) Foreign Application Priority Data
Nov. 24, 2020 (TW) 109141099

(51) Int. Cl. D01F 8/14; D04H 3/011

(52) U.S. Cl. CPC D01F 8/14; D10B 2401/04; D10B 2331/04; D04H 3/011

(57) ABSTRACT

A heat-bondable fiber includes a core portion that includes a polymeric material selected from the group consisting of a polyester, a polyolefin, a polyamide, and combinations thereof; and a sheath portion made from a copolyester and surrounding the core portion. The copolyester has a melt flow index of not smaller than 11.5 g/10 min determined according to ASTM D2128-2010 at 120° C. A nonwoven fabric includes at least one matrix fiber and at least one the Heat-bondable fiber that are thermally bonded together. The matrix fiber is made from a polymeric material selected from the group consisting of a polyolefin, a polyester, cotton, and combinations thereof.

### CROSS-REFERENCE TO RELATED APPLICATION

This application claims priority of Taiwanese Invention Patent Application No. 109141099, filed on Nov. 24, 2020.

### FIELD

The disclosure relates to a conjugate fiber, and more particularly to a heat-bondable fiber having sheath-core structure and a nonwoven fabric including the heat-bondable fiber.

### BACKGROUND

A nonwoven fabric is generally made from matrix fibers which are bonded together through a processing treatment such as a chemical treatment, a mechanical treatment, a high temperature treatment and a solvent treatment. To ensure the nonwoven fabric has sufficient breaking strength and could be widely employed for making nonwoven fabric products. A heat-bondable polyester fiber might be conventionally added to bond with the matrix fibers. Common examples of the matrix fibers are polyolefin, polyester and cotton, yet these matrix fibers usually have a melting point lower than that of the heat-bondable polyester fiber. In order to conduct thermal bonding, it is desirable to lower the melting point of the heat-bondable polyester fiber by, e.g., adding a modifier during preparation of the heat-bondable polyester fiber

Several modifiers are conducive to lower a melting point of the heat.-bondable polyester fiber. For example, U.S. Pat. No. 4,418,116 discloses use of diethylene glycol (DEG) in sufficient amount to make a copolyester binder filament that has a relatively lower melting pointe Although the resultant copolyester binder filament can be bonded to the matrix fibers, it has a relatively large size deviation, and the nonwoven fabric thus obtained exhibits inadequate breaking strength.

U.S. Pat. No. 6,139,954 discloses polyesters containing neopentyl glycol MPG) and fibers formed therefrom. However, the fibers might have a relatively large shrinkage percentage, resulting in the nonwoven fabric made therefrom having a poor size stability. In addition, Taiwanese Invention Patent Publication. No. 1650343 discloses use of 2-methyl-1,3-propanediol (MPDO) to make a polyester fiber with advanced adhesive strength, however, the nonwoven fabric made therefrom still has inadequate breaking strength.

Taiwanese Invention Patent Publication No. 1371508 discloses a core/sheath type conjugate fiber that includes a fiber forming resin component as a core and a thermoadhesive resin component as a sheath. The thermoadhesive resin component is a crystalline polyester which has a melt flow index (also called melt flow rate) less than 1.0 /min for measurements at 110° C., 120° C and 140° C. This indicates that such crystalline polyester might have a poor fluidity at temperature ranging from 110° C to 140° C., so a relatively high bonding temperature would be required for making the nonwoven fabric, which may cause damage to the properties of the fiber and incur undesirably high energy consumption.

Therefore, researchers in this field endeavor to develop a heat-bondable polyester fiber that have superior processibility and size stability, so that a nonwoven fabric made therefrom can have a sufficient breaking strength.

### SUMMARY

Therefore, an object of the disclosure is to provide a heat-bondable fiber and a nonwoven fabric that can alleviate at least one of the drawbacks of the prior art.

According to the disclosure, the heat-bondable fiber includes a core portion and a sheath portion. The core portion includes a polymeric material selected from the group consisting of a polyester, a polyolefin, a polyamide, and combinations thereof. The sheath portion is made from a copolyester and surrounds the core portion. The copolyester has a melt flow index (MI) of not smaller than 11.5 g/10 min determined according to ASTM D1238-2010 at 120° C.

According to the disclosure, the nonwoven fabric includes at least one matrix fiber and at least one heat-bondable fiber as mentioned above that are thermally bonded together. The matrix fiber is made from a polymeric material selected from the group consisting of a polyolefin, a polyester, cotton, and combinations thereof.

### DETAILED DESCRIPTION

The present disclosure provides a heat-bondable fiber which is a conjugate fiber that includes a core portion and a sheath portion surrounding the core portion. A weight ratio of the core portion to the sheath. portion may range from 10:90 to 90:10, such as 30:70 to 70:30, or 40:60 to 60:40, or 50:50.

The core portion includes a polymeric material selected from the group consisting of a polyester, a polyolefin, a polyamide, and combinations thereof. Examples of the polyester may include but are not limited to polyethylene terephthalate (PET), polytrimethylene terephthalate (PIT), polybutylene terephthalate (PET) and polyethylenenahalate (PEN). Examples of the polyolefin may include but are not limited to polypropylene (PP) and polyethylene (PE). Examples of the polyamide may include but are not limited to nylon 6, nylon 66 and nylon 56.

The sheath portion is made from an amorphous copolyester. The amorphous copolyester does not show a substantial melting point by differential scanning calorimetry when scanned at a rate of 20° C./min.

The copolyester has a melt flow index of not smaller than 11.5 g/10 min determined according to ASTM D1238-2010 at 120° C. In certain embodiments, the copolyester has a melt flow index ranging from 11.5 g/10 min to 20.0 g/10 min determined according to ASTM D1238-2010 at 120° C.

The copolyester may have a melt flow index of not smaller than 19.0 g/10 min determined according to ASTM D1238-2010 at 140° C. In certain embodiments, the copolyester has a melt flow index ranging from 19.0 g/10 min to 25.0 g/10 min determined according to ASTM D1238-2010 at 140° C.

The copolyester may have a melt flow index of not smaller than 10.0 g/10 min determined according to ASTM D1238-2010 at 110° C. In certain embodiments, the copolyester has a melt flow index ranging from 10.0 g/10 min to 15.0 g/10 min determined according to ASTM D1238-2010 at 110° C.

The copolyester may be prepared by polycondensation of a composition which includes terephthalic acid and a diol component. The diol component may include a straight-chain alkanediol having two to four carbon atoms (i.e., C₂ to C₄ straight-chain alkanediol), an ether diol having four to six carbon atoms (i.e., C₄ to C6 ether diol), and a dialkyl-substituted alkanediol having five to seven carbon atoms (i.e., C₅ to C₇ dialkyl-substituted alkanediol). Based on a total molar amount of the diol component, the ether diol may be present in an amount ranging from 12 mol % to 22 mol %, and the dialkyl-substituted alkanediol may be present in an amount ranging from 13 mol % to 33 mol %. A molar ratio of the ether diol to the dialkyl-substituted alkanediol may be not less than 0.60. In certain embodiments, based on the total molar amount of the diol component, the ether diol is present in an amount ranging from 14 mol % to 22 mol %, and the dialkyl-substituted alkanediol is present in an amount. ranging from 20 mol % to 30 mol %. In other embodiments, based on the total molar amount of the diol component, the dialkyl-substituted alkanediol is present in an amount ranging from 22 mol % to 25 mol %.

In still other embodiments, in the diol component, the molar ratio of the ether diol to the dialkyl-substituted alkanediol ranges from 0.60 to 1.20. In yet other embodiments, the molar ratio of the ether diol the dialkyl-substituted alkanediol ranges from 0.65 to 1.00.

Examples of the straight-chain alkanediol may include, but are not limited to, ethylene glycol (EC), 1,3-propanediol, 1,4-butanediol, and combinations thereof.

Examples of the ether dial may include, but are not limited to, diethylene glycol (DEG) triethylene glycol (TEG), and a combination thereof.

Examples of the dialkyl -substituted alkanediol may include, but are not limited to, neopentyl glycol (NPG, CAS No. 126-30-7), 2-methyl-1,3-pentanediol (CAS No. 149-31-5) and a combination thereof.

The composition may be free of a monoalkyl-substituted alkanediol. Example of the monoalkyl-substituted alkanediol is 2-methyl-1,3-propanediol (MPDO, CAS No. 2163-42-0)

The copolyester may have a glass transition temperature ranging from 59.0° C to 64.0° C.

The copolyester may have a softening point ranging from 105.0° C to 116.0° C.

The heat-bondable fiber may have a hot-air shrinkage of not greater than 6.8% under dry heat at 85° C. for 15 minutes.

The present disclosure also provides a nonwoven fabric which includes at least one matrix fiber and at least one heat-bondable fiber as mentioned above that are thermally bonded together. The matrix fiber is made from a polymeric material selected from the group consisting of a polyolefin, a polyester, cotton, and combinations thereof. In an exemplary embodiment of this disclosure, the matrix fiber is made from a polyester.

The nonwoven fabric may have a nonwoven fabric breaking strength Greater than 20.0 kgf which is determined according to ISO 9073-3:1989 at 25° C. In certain embodiments, the nonwoven fabric breaking strength of the nonwoven fabric ranges from 20.5 kgf to 26.5 kgf determined according to ISO 9073-3:1989 at 5° C.

The nonwoven fabric may have a shrinkage percentage of not greater than 30.0% when a plurality of the matrix fibers and a plurality of the heat-bondable fibers are thermally bonded at 145° C. for 5 minutes. In certain embodiments, the nonwoven fabric has a shrinkage percentage ranging from 25.0% to 30.0% when the matrix fibers and the heat-bondable fibers are thermally bonded at 145° C. for 5 minutes.

Examples of the disclosure will be described hereinafter. It is to be understood that these examples are exemplary and explanatory and should not be construed as a limitation to the disclosure.

### Preparation of Prepolymer

### Example 1 (E1)

Terephthalic acid (TEA), ethylene glycol (EG) diethylene Glycol (DEC) and neopentyl glycol (NEC) were mixed in a molar ratio as shown in Table 1 in an autoclave batch reactor weighing 1 ton, wherein a molar ratio of DEG to NPG was 0.82. The resultant mixture was subjected to an esterification reaction at a temperature of 250° C. and a pressure of 3 kg/cm² for a time period ranging from 5 hr to 6 hr so as to obtain a prepolymer of E1.

### Example 2 (E2)

The prepolymer of E2 was prepared using procedures similar to those of E1, except that the molar ratio of TPA, EG, DEG and NPG was varied as shown in Table 1, and the molar ratio of DEG to PPG was 0.64.

### Example 3 (E3)

The prepolymer of E3 was prepared using procedures similar to those of E1, except that the molar ratio of TPA, EG, DEG and PPG was varied as shown in Table 1, and the molar ratio of DEG to NPG was 0.75.

### Example 4 (E4)

The prepolymer of E4 was prepared using procedures similar to those of E1, except that the molar ratio of TPA, EG, DEG and NPG was varied as shown in Table 1, and the molar ratio of DEG to PPG was 1.00.

### Comparative Example 1 (CE1)

The prepolymer of CE1 was prepared using procedures similar to those of E1, except that the molar ratio of TPA, EC, DEG and PPG was varied as shown in Table 1, and the molar ratio of DEG to NPG was 0.50.

### Comparative Example 2 (CE2)

The prepolymer of CE2 was prepared using procedures similar to those of E1, except that PPG was replaced with isophthalic acid (IPA), and TPA, EG, DEG and IPA were mixed in a molar ratio as shown in Table 1.

### Comparative Example 3 (CE3)

The prepolymer of CE3 was prepared using procedures similar to those of E1, except that DEG was omitted, and TPA, EG and NPG were mixed in a molar ratio as shown in Table 1.

### Comparative Example 4 (CE4)

The prepolymer of CEA was prepared using procedures similar to those of E1, except that DEG and NPG were replaced with MPDO, and TPA, EG and MPDO were mixed in a molar ratio as shown in Table 1.

### Comparative Example 5 (CE5)

The prepolymer of CE5 was prepared using procedures similar to those of E1, except that MPDO was further added, and TPA, PG, DEG, NPG and MPDO were mixed in a molar ratio as shown in Table 1.

### Comparative Example 6 (CE6)

The prepolymer of CE6 was prepared using procedures similar to those of E1, except that NPG was replaced with MPDO, and TPA, EG, DEG and MPDO were mixed in a molar ratio as shown in Table 1.

### Comparative Example 7 (CE7)

The prepolymer of CE7 was prepared using procedures similar to those of E1, except that EG, DEG, NPG were replaced with IPA and 1,4-butanediol (1,4-BG), and TPA, IPA and BG were mixed in a molar ratio as shown in Table 1.

TABLE 1

| | | | | | Other | DEG/NPG |
|---|---|---|---|---|---|---|
| | TPA | EG | DEG | NPG | modifier | (molar |
| | (mol %) | (mol %) | (mol %) | (mol %) | (mol %) | ratio) |
| E1 | 100 | 60 | 18 | 22 | — | 0.82 |
| E2 | 100 | 64 | 14 | 22 | — | 0.64 |
| E3 | 100 | 58 | 18 | 24 | — | 0.75 |
| E4 | 100 | 56 | 22 | 22 | — | 1.00 |
| CE1 | 100 | 70 | 10 | 20 | — | 0.50 |
| CE2 | 61.5 | 90 | 10 | — | IPA | N/A |
| | | | | | 38.5 | |
| CE3 | 100 | 74 | — | 26 | — | 0.00 |
| CE4 | 100 | 55 | — | — | MPDO | N/A |
| | | | | | 45 | |
| CE5 | 100 | 62 | 18 | 10 | MPDO | 1.80 |
| | | | | | 10 | |
| CE6 | 100 | 63 | 25 | — | MPDO | N/A |
| | | | | | 12 | |
| CE7 | 80 | 50 | — | — | IPA 20 | N/A |
| | | | | | 1,4-BG | |
| | | | | | 50 | |

Note:
“—” indicates not added, and “N/A” indicates not applicable.

### Preparation of Copolyester Resin

Based on 100 parts by weight of the arepolymer, 0.03 parts by weight of antimony trioxide (serving as a catalyst) and 0.008 parts by weight of trimethyl phosphate (serving as a heat stabilizer) were added into each of the prepolymers of E1 to E4 and CEI to CE7. Then, a respective one of the resultant mixtures was subjected topolycondensation at a temperature of 280° C. under vacuum condition of less than 1 torr for a time period ranging from 4.5 hr to 6.0 hr, so as to obtain copolyester resins of E1 to E4 and CE1 to CE7, respectively.

### Property Evaluations of Copolyester Resin

### Viscosity Measurement

0.5 g of each of the copolyester resins of E1 to P4 and CE 1 to CE7 was dissolved in m-cresol, followed by measurement of a relative viscosity (RV, ηᵣ) thereof using an libbelohde viscometer at a temperature ranging from 100° C to 110° C. The results are shown in Table 2.

### Thermal Analysis

The copolyester resins of E1 to E4 and CE1 to CE7 were subjected to thermal analysis using a differential scanning calorimeter (DSC) (TA Instruments, Model no.: Q2000) to determine thermal transitions thereof. The results show that the copolyester resins of E1 to E4 and CE1 to CE6 are amorphous. A glass transition temperature (I_{q}) and a softening point (Tₛ) of each of the copolyester resins are also determined. The results are shown in Table 2.

TABLE 2

| | RV | Tg (° C.) | Tg (° C.) |
|---|---|---|---|
| E1 | 1.568 | 61.7 | 109.0 |
| E2 | 1.566 | 63.5 | 115.3 |
| E3 | 1.561 | 61.3 | 106.0 |
| E4 | 1.559 | 60.9 | 107.0 |
| CE1 | 1.560 | 72.0 | 126.2 |
| CE2 | 1.568 | 68.0 | 110.0 |
| CE3 | 1.576 | 78.5 | 135.9 |
| CE4 | 1.566 | 61.5 | 109.0 |
| CE5 | 1.563 | 61.7 | 111.0 |
| CE6 | 1.565 | 58.3 | 112.1 |
| CE7 | 1.557 | 45.0 | N/A |

Note: “N/A” indicates not applicable.

It can be seen from. Table 2 that all of the copolyester resins of E1 to 14 and CE1 to CE7 have RV values within a range of 1.557 to 1.576. In addition, the glass transition temperature of all of the copolyester resins of E1 to E4 and CE1 to CE7 ranges from 45.0° C. to 73.5° C. The softening point of the copolyester resins of E1 to E4, CE2, and CE4 to CE6 ranges from 106.0° C to 115.8° C. In comparison, the copolyester resins of CE1 and CE3 respectively have a softening point of 126.2° C and 135.9° C., indicating that a heat-bondable fiber made from the copolyester resin of CE1 or CE3 needs a relatively higher processing temperature to bring sufficient bonding strength so as to bond with matrix fibers for preparing a nonwoven fabric, however, higher processing temperature might easily cause damage to the matrix fibers. In addition, each of the copolyester resins of E1 to E4 does not show a substantial melting point, while the copolyester resin of CE7 has a melting point of approximately 155.0° C. copolyester resin having a substantial melting point may require a high bonding temperature in subsequent preparation of a nonwoven fabric, such as 180° C., as disclosed in Taiwanese Invention Patent Publication No. I371508.

### Measurement of Melt Flow Index

Each of the copolyester resins of E1 to E4 and CE1 to CE6 was analyzed using a melt flow indexer (GOTECH Testing Machines Inc., Model no.: GT-7100-MIB) at. 110° C., 120° C and 140° C. under a loading of 2.16 kg according to ASTM D1238-2010 (n=10). The average melt flow indices of each of the copolyester resins determined at different temperatures are shown in Table 3.

TABLE 3

| | 110° C. | 120° C. | 140° C. |
|---|---|---|---|
| | (g/10 min) | (g/10 min) | (g/10 min) |
| E1 | 10.3 | 12.1 | 19.2 |
| E2 | 10.0 | 11.9 | 19.1 |
| E3 | 11.9 | 13.8 | 20.5 |
| E4 | 12.3 | 14.0 | 22.1 |
| CE1 | 8.9 | 11.1 | 15.9 |
| CE2 | 9.1 | 10.8 | 15.8 |
| CE3 | 7.6 | 9.1 | 11.1 |
| CE4 | 9.8 | 11.0 | 18.2 |
| CE5 | 9.9 | 11.1 | 18.1 |
| CE6 | 9.0 | 11.2 | 18.2 |
| CE7 | <1.0 | <1.0 | <1.0 |

It is noted that the melt flow index represents degree of molecular movement of the copolyester resin at the testing temperature. The copolymer having a greater melt flow index means a higher degree of molecular movement thereof, and thus, has an improved flowability. When a sheath portion of a heat-bondable fiber as made from such copolyester resin, the heat-bondable fiber is capable of exhibiting an improved bonding strength during thermal bonding process, thereby enhancing strength of a nonwoven fabric made therefrom.

It can be seen from Table 3 that the copolymer resins of E1 to 14 have a melt flow index measured at. 110° C. that ranges from 10.0 G/10 min to 12.3 g/10 min, a melt flow index measured at 120° C that ranges from 11.9 g/10 min to 14.0 g/10 min, and a melt flow index measured at 140° C that ranges from 19.1 g/10 min to 22.1 g/10 min. In comparison, all of the copolymer resins of CE1 to CE6 have a melt flow index measured at 110° C. that is not greater than 9.9 g/10 min, which only ranges from 7.6 g/10 min to 9.1 g/10 min for CE1 and CE3. In addition, all of the copolymer resins of CE1 to CE6 have a melt. flow index measured at 120° C that is not greater than 11.2 g/10 min (from 9.1 g/10 min to 11.2 g/10 min), and a melt flow index measured at 140° C that is not greater than 18.2 g/10 min (from 11.1 g/10 min to 18.2 g/10 min). These results indicate that as compared with E1 to 14, the copolyester resins of CE1 to CE6 have inadequate and poor processing flowability.

Moreover, the copolymer resin of CE7 has a melt flow index less than 1.0 g/10 min for all measurements at 110° C., 120° C., and 140° C. This indicates that the copolymer resin of CE7 has poor flowability even at 140° C., and thus is deemed to be not suitable for use in the preparation of heat-bondable fiber involving a bonding process to be conducted at a temperature of e.g., 145±3° C as discussed below.

### Preparation of Heat-Bondable Fiber Having Sheath-Core Structure

The copolyester resin of each of E1 to P4 and. CE1 CE6 was melted at 230° C., and polyethylene terephthalate (PET, produced by Far Eastern New Century Corporation, Model no.: CS-515) was melted at 280° C. The melted copolyester resin and PET (respectively serving as a sheath portion and a core portion, in a weight ratio of 50:50) were melt spun using a single screw extruder (purchased from Barmaq Model no. 6E4) equipped with a sheath-core bicomponent spinneret (1080-micropore) that has an orifice diameter of 0.45 mm at a spinning rate of 900 m/min. The resultant melt-spun product was solidified by cool air (an inlet air temperature of 14° C., an inlet air pressure of 210 bar, an outlet air temperature of 51° C., and an outlet air pressure of −65 bar), followed by exposure to a spin finish oil to form a filament. Then, the filament was subjected to multi-stage drawing at a temperature ra.nqing from 50° C to 60° C. so as to achieve a drawing ratio of 3.5, followed by cutting using a crimper at a temperature ranging from 25° C to 30° C to obtain a heat-bondable fiber having sheath-core structure and a length of 51 mm (hereafter referred to as a spun sample). The spun sample made from the copolyester resin of each of E1 to E4 and CE1 to CE6 was subjected to the following analysis.

### Measurement of Tensile Strength and Elongation

The tensile strength and elongation of the spun samples were determined using a tensile tester (Lenzing Instruments GmbH & Co. KG, Model no.: Vibrodyn 400). Specifically, the spun sample (n=30) was clamped at a distance of 20 mm from an end thereof and then stretched at a speed of 36 mm/min according to JIS 11015 (2010) The average tensile strength (g/denier) and elongation (%) for each spun sample are shown in Table 4.

### Measurement of Hot-Air Shrinkage

The spun samples were placed in an oven and subjected to dry heating at 85° C. for 15 minutes. The length of the spun sample (n=6) before and after dry heating was measured, and a hot-air shrinkage of the spun sample was determined according to the following equation (1).

A=[(B−C)/B)]×100% (1)

wherein: A=hot-air shrinkage (%)
B=length of the spun sample before dry heating
C=length of the spun sample after dry heating

The average hot-air shrinkage for each spun sample is shown in Table 4.

TABLE 4

| | Tensile | Elongation | Hot-air |
|---|---|---|---|
| | strength (g/d) | (%) | shrinkage (%) |
| E1 | 3.2 | 68 | 6.6 |
| E2 | 3.3 | 67 | 6.5 |
| E3 | 3.2 | 69 | 6.8 |
| E4 | 3.3 | 67 | 6.5 |
| CE1 | 3.1 | 57 | 8.0 |
| CE2 | 3.3 | 66 | 7.0 |
| CE3 | 3.0 | 73 | 8.2 |
| CE4 | 3.4 | 68 | 6.8 |
| CE5 | 3.4 | 70 | 7.0 |
| CE6 | 3.3 | 69 | 6.9 |

It can be seen from Table 4 that the tensile strength of each of the sheath-core spun samples of E1 to E4 and CE1 to CE6 ranges from 3.0 g/d to 3.4 g/d. The elongation of each of the sheath-core spun samples of E1 to 114 and CE1 to CE6 ranges from 57% to 73%. The hot-air shrinkage of the sheath-core spun sample of E1 to E4 and CE1, CE2 and CE4 to CE6 is not greater than 7.0%. In comparison, the sheath-core spun samples of CE1 and CE3 have a hot-air shrinkage reaching 8.0% and 8.2%, respectively, indicating that the heat-bondable fiber made from the copolyester resin of CE1 or CE3 sign ficantly shrinked after heating, resulting in a reduced bonding region for bonding with matrix fibers during thermal bonding process, and thus, a nonwoven fabric produced from such heat-bondable fiber would have a decreased size stability.

### Preparation of Nonwoven Fabric

12.5 g of each of the spun samples of E1 to P4 and CE1 to CE6 was mixed with 37.5 g of a 6D hollow fiber (polyester fiber serving as a matrix fiber), and then carded using a carding machine to forma respective one of fabric sheets having a thickness of 1.5 cm. Each of the fabric sheets was cut into several fabric pieces with a size of 25 cm×5 cm, followed by heating in an oven having a temperature of 145±3° C. for 5 minutes to conduct thermal bonding, and then cooling to room. temperature, thereby obtaining nonwoven fabrics of E1 to E4 and CE1 to CE6.

### Measurement of Nonwoven Fabric Shrinkage Percentage

For each of E1 to E4 and CE1 to CE6, two fabric pieces as prepared above (each having a size of 25 cm×36 cm) were heated in an oven having a temperature of 145±3° C. for 5 minutes to conduct thermal bonding. A total length of an upper section, a middle section and a lower section of each of the two fabric pieces of E1 to E4 and CE1 to CE6 (n=5) before and after heating was measured, and a shrinkage percentage was determined according to the following equation (2).

D=[(E−F)/E)]×100% (1)

wherein: D=shrinkage percentage
E=the total length of the upper, middle and lower sections of the two fabric pieces before heating
F=the total length of the upper, middle and lower sections of the two fabric pieces after heating

The average shrinkage percentage of the nonwoven fabrics for each of E1 to E4 and CE1 to CE6 is shown in Table 5.

### Measurement of Nonwoven Fabric Breaking Strength

The breaking strength of each of the nonwoven fabrics of E1 to E4 and CE1 to CE6 (n=6) was determined using a universal testing machine (Cometech Testing Machines Co., Ltd, Model no. QC-542F) according to ISO 9073-:1989 at 25° C. The results are shown in Table 5.

TABLE 5

| | Nonwoven fabric | Nonwoven fabric |
|---|---|---|
| | shrinkage percentage | breaking strength |
| | (%) | (kgf) |
| E1 | 29.9 | 23.2 |
| E2 | 25.0 | 20.6 |
| E3 | 26.5 | 23.2 |
| E4 | 29.2 | 26.2 |
| CE1 | 39.0 | 11.1 |
| CE2 | 35.0 | 17.5 |
| CE3 | 76.2 | 8.1 |
| CE4 | 31.1 | 20.0 |
| CE5 | 31.0 | 18.5 |
| CE6 | 30.6 | 18.6 |

It can be seen from Table 5 that when the matrix fibers and the heat bondable fibers are thermally bonded at 145° C. for 5 minutes, the shrinkage percentage of each of the nonwoven fabrics of E1 to E4 ranges from 25.0% to 2.9.9%, whereas the shrinkage percentage of each of the nonwoven fabrics of CE1 to CE6 is relatively higher (all not lower than 30.6%, i.e., 30.6% to 76.2%), indicating that the nonwoven fabrics of CE1 to CE6 (particularly CE1 to CE3) have lower size stability during the preparation process. In addition, the breaking strength of each of the nonwoven fabrics of E1 to E4 ranges from 20.6 kgf to 26.2 kgf , whereas the nonwoven fabrics of CE1 to CE6 all have a relatively lower breaking strength. (not greater than 20.0 kgf, i.e., 8.1 kgf to 20.0 kgf).

To conclude, by inclusion of the copolyester having a melt flow index of not smaller than 11.5 g/10 min at. 120° C., the heat-bondable fiber of the present disclosure can exhibit superior processibility and size stability, and thus, the nonwoven fabric made therefrom is conferred with excellent breaking strength.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an. ordinal number and so forth means that a particular feature, structure, or characteristic maybe included in the practice of the disclosure. It should be further appreciated that in the description, various features are sometimes grouped together in a single embodiment, figure, or description thereof for the purpose of streamining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but intended to cover various arrangements included within the spirit and scope of the broadest interpretation so as to encompass all such modifications and equivalent arrangements.

What is claimed is:

1. A heat-bondable fiber, comprising:
a core portion comprising a polymeric material selected from the group consisting of a polyester, a polyolefin, a polyamide and combinations thereof; and
a sheath portion made from a copolyester and surrounding said core portion, said copolyester having a melt flow index of not smaller than 11.5 g/10 min determined according to ASTM D1238-2010 at 1120° C.

2. The heat-bondable fiber of claim 1, wherein said copolyester has a melt flow index of not smaller than 19.0 g/10 min determined according to ASTM D1238-2010 at 140° C.

3. The heat-bondable fiber of claim 1, wherein said copolyester has a melt flow index of not smaller than 10.0 g/10 min determined according to ASTM D238-2010 at 110° C.

4. The heat-bondable fiber of claim 1, wherein said copolyester is amorphous.

5. The heat-bondable fiber of claim 1, which has a hot-air shrinkage of not greater than 6.6% under dry heat at 85° C. for 15 minutes.

6. The heat-bondable fiber of claim 1, wherein said copolyester is prepared by polycondensation of a composition which includes terephthalic acid and a diol component, said dial component including a straight-chain alkanediol having two to four carbon atoms, an ether diol having four to six carbon atoms and a dialkl-substituted alkanediol having five to seven carbon atoms, wherein based on a total molar amount of said component, said ether diol is present in an amount ranging from 12 mol % to 22 mol %, and said dialkyl-substituted alkanediol is present in an amount ranging from 13 mol % to 33 mol %.

7. The heat-bondable fiber of claim 6, wherein a molar ratio of said ether diol to said dialkyl-substituted diol is not less than 0.60.

8. The heat-bondable fiber of claim 7, wherein the molar ratio of said ether dial to said dj alkyl-substituted alkanediol ranges from 0.60 to 1.00.

9. The heat-bondable fiber of claim 6, wherein said composition is free of a monoalkyl-substituted alkanediol.

10. The heat-bondable fiber of claim 6, wherein said straight-chain alkanediol is selected from the group consisting of ethylene glycol, 1,3-propanediol, 1,4-butanediol, and combinations thereof.

11. The heat-bondable fiber of claim 6, wherein said ether diol is selected from the group consisting of diethylene glycol, triethylene glycol, and a combination thereof.

12. The heat-bondable fiber of claim 6, wherein said dialkyl-substituted alkanediol is selected from the group consisting neopentyl glycol, 2-methyl-1,3-pentanediol, and combination thereof.

13. The heat-bondable fiber of claim 1, wherein said copolyester has a glass transition temperature ranging from 59.0° C to 64.0° C.

14. The heat-bondable fiber of claim 1, wherein said. copolyester has a softening point ranging from 105.0° C to 116.0° C.

15. A nonwoven fabric, comprising:
at least one matrix fiber and at least one heat-bondable fiber as claimed in claim 1 that are thermally bonded together, wherein said matrix fiber is made from a polymeric material selected from the group consisting of a polyolefin, a polyester, cotton, and combinations thereof.

16. The nonwoven fabric of claim 15, which has a nonwoven fabric breaking strength greater than 20.0 kgf which is determined according to ISC 9073-3:1989 at 25° C.

17. The nonwoven fabric of claim 15, which has a shrinkage percentage of not greater than 30.0% when a plurality of said matrix fibers and a plurality of said heat-bondable fibers are thermally bonded at 145° C. for 5 minutes.
